(19) United States
(12) Patent Application Publication
(10) Pub. No.: US 2003/0002926 A1
(43) Pub. Date: Jan. 2, 2003

(54) Speed feeder

(76) Inventor: Ernest Andrew Webb, Orange, TX (US)

Correspondence Address: Richard J. Tholstrup, FRIEDRICH & THOLSTRUP, Suite 1750, 440 Louisiana, Houston, TX, 77002, US

(21) Appl. No.: 09/882,622

(22) Filed: Jun. 15, 2001

(51) Int. Cl. B65G 51/18

(52) U.S. Cl. 406/191

(57) ABSTRACT

An animal feeder hopper loading system for loading animal feeders in remote, elevated locations. The system contains a hopper for loading feed at ground or truck bed level, and an air movement device coupled with a simple but unique control mechanism for regulating the flow of feed from the loading system hopper to a flexible hose which discharges feed into the receiving animal feeder hopper.

### BACKGROUND

1. Field of the Invention

The present invention relates to a feed conveyance system, specifically a unique means of delivering animal feed from a hopper by pneumatic conveyance to an elevated animal feeder in a remote field location.

2. Description of Related Art

The problem to which this invention is directed is developing a system by which a user can efficiently load an elevated animal feeder. Traditionally, loading an elevated animal feeder in a remote field location is accomplished by carrying bagged feed up a ladder, lifting the heavy bag above the user's shoulders and manually dumping the contents. The present invention replaces the current method of carrying and lifting with convenient and practical pneumatic conveyance.

A primary concern of those interested in promoting animal populations for recreational hunting is the supplementation of nutrient sufficient food supplies during those times when naturally occurring forage is not adequate to support dependent animal populations. This is especially true during the fall and winter months; the time for most recreational hunting.

Over the years, automated remote animal feeders have been developed which are intended to automatically dispense a predetermined quantity of feed to the availability of the animals over time. Animal feeders are elevated by design above a height where there might be interference by a foraging animal. Such animal feeders may be wind powered or powered by small electric devices using common batteries. While these feeding systems are efficient at dispensing the feed, the feeding systems have to be periodically recharged manually with feed. U.S. Pat. Nos. 5,926,441 to Zinsmeyer et al. (1999) and 5,873,326 to Davet (1999) dispense feed by means of an electric motor and timer. The timer activates the motor and the motor provides the means to distribute animal feed on the ground or in troughs on set intervals. While efficient at dispensing the feed, this type of design does not provide any means for loading the feeder, only the dispensing of loaded feed.

Other animal feeding systems are wind- or movement-powered, thereby eliminating the need for electricity or batteries as described above. With the foregoing in mind, there is a pressing need for an efficient means to load these elevated animal feeding systems. All the above referenced systems, provide a system for disbursing feed. All have the disadvantage of having to be manually loaded. There is no system for non-manual loading of an animal feeder.

### OBJECTS AND ADVANTAGES

Accordingly, it is an object of the present invention to provide a conveyance system for loading a remote animal feeder hopper, more safely, efficiently, conveniently, and in less time than the traditional manual method. The referenced art provides no means for loading the animal feeder hopper. The present invention's emphasis is on the loading of the animal feeder hopper. The employed equipment can remain in the bed of a truck or on the ground and provides an efficient method for loading a feeder hopper. A predetermined amount of feed will be placed in the Speed Feed hopper. Then, a flexible hose will be extended into the feeder hopper, the blower started, and the feed pneumatically conveyed into the elevated feeder hopper.

An advantage of the present invention is safety in that it does not require an individual to climb a ladder while lifting a heavy feed bag above one's shoulders. Injuries often occur while loading elevated feeder hoppers in this manner; an individual may lose their balance and fall off of a ladder or otherwise sustain injury because of the required lifting.

It is another advantage of the present invention to provide a new and improved apparatus for avoiding the intense manual labor of loading feeder hoppers.

It is a further object of the present invention to provide a new and improved apparatus for loading a feeder hopper which may be easily and efficiently manufactured and marketed.

Another object of the present invention is to provide a new and improved apparatus for loading a feeder hopper which is of durable and reliable construction.

An even further object of the present invention is to provide a new and improved apparatus for loading a feeder hopper which is susceptible of a low cost of manufacture with regard to both materials and labor, and which accordingly is then susceptible of low prices of sale to the consuming public, thereby making such apparatus for loading a feeder hopper economically available to the buying public.

### DRAWING FIGURES

FIG. 1 shows a plan view of the basic version of the Speed Feed system.

FIG. 2 shows an interiorly overhead view of the Speed Feed system's hopper.

### REFERENCE NUMERALS IN DRAWINGS

| | | | |
|---|---|---|---|
| 10 | flexible hose | 40 | barrel |
| 20 | loading hopper | 41 | elbow |
| 21 | opening | 42 | y-joint |
| 22 | inclined boffom | 50 | brace |
| 23 | support legs | 60 | air wand reducer/seal |
| 24 | flange | 70 | air movement device |
| 25 | hopper interior | 71 | air supply pipe |
| 26 | bottom loading hopper | | |
| 30 | coupling | | |

### SUMMARY

In accordance with the present invention, a feed delivery system for conveying animal feed to a remote, elevated animal feeder hopper.

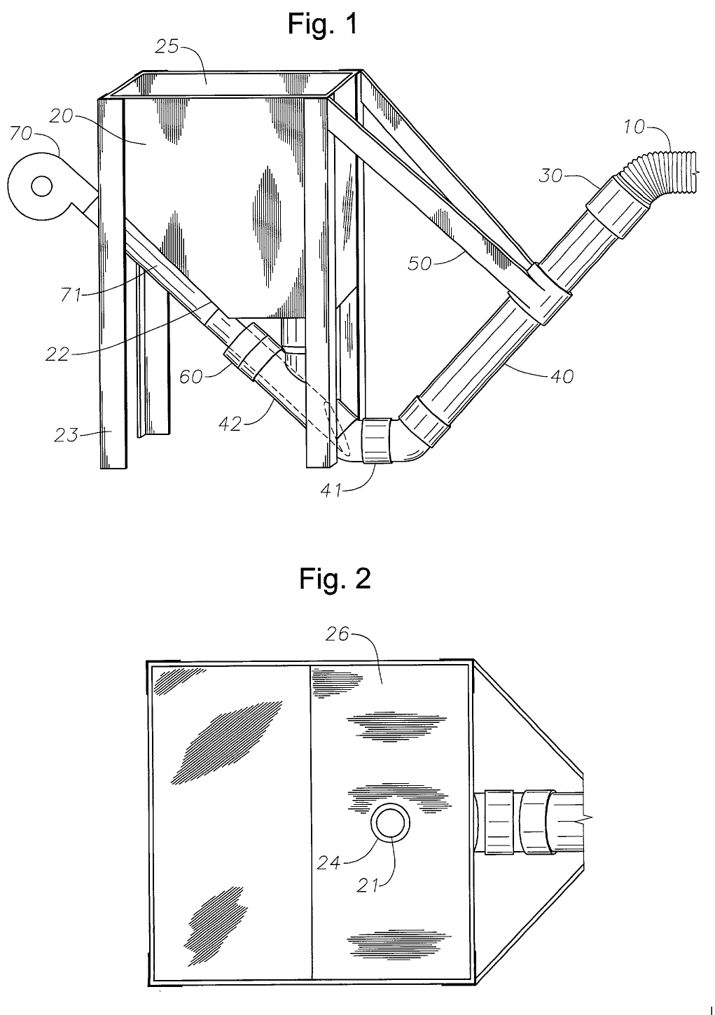

### Description-FIGS. 1 & 2

A typical embodiment of the present invention is illustrated in FIGS. 1 and 2. The loading hopper 20 consists of the hopper interior 25, opening 21 located at the bottom of the loading hopper, an inclined bottom 22, support legs 23, loading hopper bottom 26, flange 24, support brace 50, y-joint 42, air wand reducer/seal 60, elbow joint 41, barrel 40, coupling 30, and the flexible hose 10. Additional parts that connect to the Speed Feed system are the air movement device 70 and air supply pipe 71.

The Speed Feed system comprises a loading hopper 20 supported by four supporting base legs 23. The interior of the loading hopper 20 has an inclined bottom 22 leading to an opening 21 on the bottom 26. A y-joint 42 connects to the bottom 26 of the loading hopper 20 via a flange 24 which seals the y-joint 42 to the loading hopper's bottom 26.

The y-joint 42 has an air wand reducer/seal 60 which attaches to and seals the air supply pipe 71. The air movement device 70 attaches to the air supply pipe 71. The y-joint 42 connects to the elbow 41. The elbow 41 attaches to the barrel 40, which leads to the coupling 30. The barrel 40 is supported by the brace 50. The coupling 30 provides a seal between the barrel 40 and flexible hose 10.

The FIG. 2, details an overhead view of the loading hopper's interior bottom 26, the embodiments include, the bottom 26 where the y-joint 42 connects to the flange 24 to create a seal.

### Operation-FIGS. 1, 2

In using the Speed Feed delivery system, an individual places feed into the loading hopper 20. The Speed Feed delivery system may be placed on the ground or the bed of a truck. This keeps the user from having to lift the feed bag beyond waist height. The inclined bottom 22 insures the feed is gravity fed to and collects in the opening 21 where the feed flows into the y-joint 42. The flexible hose 10 is manually extended to and placed in receiving position in an elevated feed hopper. The flexible material of the flexible hose 10 allows the hose to be raised, lowered, and/or located in various elevations to supply feeder hoppers of varying elevations. A self powered air movement device 70 or blower is attached to the air supply pipe 71. Once the seal has been made between the air supply pipe 71 and the air wand reducer/seal 60, the user will then start the air movement device 70. The position of the exit end of the air supply pipe 71 is manipulated longitudinally within the y-joint 42 by the operator to control the feed conveyance. The feed is conveyed through the barrel 40 into the flexible hose 10 and discharged into the elevated feeder.

### Conclusion, Ramifications, and Scope

The reader will see that this Speed Feed delivery system can be used to efficiently supply or load an elevated feed hopper. The present invention is of relative light weight, convenient, easily assembled, conveniently stored, and practical. In addition, the system focuses on providing a compact and effective system for the filling elevated hoppers. Furthermore, the Speed Feed delivery system has additional advantages in that

it permits an immediate delivery of feed to differing heights via the flexible hose.

it permits a user to efficiently fill successive feeder hoppers as the system can be transported on the bed of a pickup truck.

it provides a rapid and efficient feed flow for filling a feed hopper.

it provides the user with a safe alternative to climbing a ladder with a heavy feed bucket or bag.

it requires limited storage space due to its compact size.

it requires a safe range of lifting for filling the loading hopper.

While the above description contains many specificities, these should not be construed as limitations on the scope of the invention, but rather as an exemplification of one preferred embodiment thereof For example, the method of dispensing the feed via the flexible hose can be modified to include varying lengths, rigidity, or other similar means. The loading hopper can be modified in shape, size, construction material, or design. The supporting leg structures may be modified with wheels including a wheel locking mechanism. These potential alternative modifications have been anticipated, however, they are not consider important enough to be shown in the drawing and or detailed description sections.

Accordingly, the scope of the invention should be determined not by the embodiments illustrated, but by the appended claims and their legal equivalents.

What is claimed is:

1. A Feed delivery system comprising:
a) a feed container body;
b) a funnel shaped outlet attachable to said container body;
c) multiple support legs attachable to said container body and extending downward below said funnel shaped outlet;
d) a y-joint comprising two upper legs and one lower leg attached by first said upper leg of said y-joint below said funnel shaped outlet;
e) an air movement pipe with a first and second end, said first end sealably and releasably inserted longitudinally into second said upper leg of said y-joint;
f) an air movement device attached to said second end of said air movement pipe;
g) an elbow with a first and second end, said first end of said elbow attached to said lower leg of said y-joint;
h) a discharge pipe with a first and second end, said firs end attached to said second end of said elbow;
i) a brace with a first and second end, with first said end attached to said feed container body and second said end attached to said discharge pipe; and
j) a coupling with a first and second end, said first end attached to said second end of said discharge pipe and second said end comprising a flexible hose connection.

2. The combination according to claim 1, wherein the location of said first end of said air movement pipe is moved longitudinally within said second upper leg of said y-joint to create an annulus resulting in reduced pressure in said first upper leg of said y-joint from air flow through said first end of said air movement pipe.

3. The combination according to claim 2, wherein said air movement device is a gasoline powered yard blower.

4. The combination according to claim 2, wherein said first end of said air movement pipe is angled with regard to the longitude pf said air movement pipe.

5. The combination according to claim 2, wherein said first end of said air movement pipe is angled at 45 degrees with regard to the longitude pf said air movement pipe.
